(19) United States
(12) Patent Application Publication
(10) Pub. No.: US 2004/0192491 A1
(43) Pub. Date: Sep. 30, 2004

(54) Assembly arrangement of an epicyclic satellite

(75) Inventors: Samuel Becquerelle, Andresy (FR); Serge Pettinotti, Courbevoie (FR); Daniel Ville, Meudon La Foret (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: HISPANO SUIZA, BOIS-COLOMBES (FR)

(21) Appl. No.: 10/756,258

(22) Filed: Jan. 14, 2004

(30) Foreign Application Priority Data
Jan. 17, 2003 (FR) 03 00478

(51) Int. Cl. F16H 57/08

(52) U.S. Cl. 475/331

(57) ABSTRACT

A satellite (3) is supported on its shaft (1) through a large number of distributed bearings, particularly roller bearings (6) and the arrangement keeps a good force distribution capability due to similar stiffnesses of parts of the shaft (1) and a bushing (7) which forms the inner part of the satellite (3), facing each other along the length of the hole.

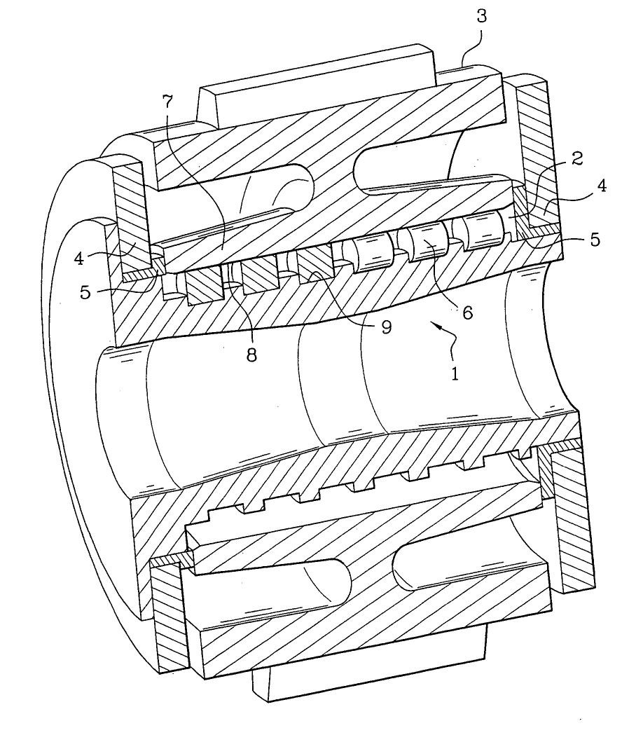

### TECHNICAL DOMAIN

The subject of this invention is an assembly arrangement for an epicyclic satellite.

One difficulty that is always encountered with these devices is the high load applied to bearings connecting the satellite to the supporting shaft and passing through the hole in it.

Therefore, the conventional assembly arrangement in which a part rotates about its shaft, comprising a pair of roller bearings close to the ends of the hole, is badly adapted in this case since it makes it necessary to use large bearings in an application in which the diameter of the satellites is limited by the general design of the epicyclic gear train. One replacement solution consists of replacing the pair of roller bearings by a single smooth bearing passing through almost all the way through the hole, but this smooth bearing must be lubricated by an oil flow and is wasteful (U.S. Pat. No. 5,102,379-A contains an example of this design).

Another solution is presented in this description, that does not require the use of a smooth bearing or the use of large roller bearings.

The arrangement comprises a fairly large number of roller bearings arranged regularly in the hole, with at least three. In this case, a roller bearing denotes a single mechanical object comprising a ring of balls, rollers or other rolling elements between the rotating parts that they support, and supported on these parts directly or through rings; and if it is supported through rings, the bearing may include other circles of rolling elements parallel to the first circle.

The load transmitted through the satellite is distributed between the bearings, which may therefore be much smaller. However, in order to fully appreciate the invention, it should be noted that the increase in the number of roller bearings does not necessarily correspondingly reduce the forces applied to them, which explains the widespread use of the assembly with two roller bearings: in general, it is impossible to equalise loads passing through the different bearings, some of which are loaded much more than others, which means that their size cannot be reduced and therefore the result is an unnecessary increase in the weight of the mechanism.

However, the inventors have observed that this disadvantage disappears provided that the stiffnesses of the bearing support bushings present on the shaft and on the satellite along the hole are similar at each pair of portions facing each other along the length of the hole. Thus, any deformation in the satellite will correspond to a similar deformation in the shaft, and the rolling elements of each bearing continue to transmit similar loads, since constraints are similar in the different bearings.

In practice, rollers are usually chosen as the rolling elements because they can transmit higher loads than balls; it is even more important that stiffnesses of facing parts of bushings on the shaft and the satellite are similar since rollers have line contacts, and a defect in the parallelism of the bushings as a result of various deformations causes a change to the force transmission capacity through the bearing rollers concerned. The use of rollers also helps to respect the requirement to keep the bearings small and the arrangement in general. It is then recommended that the rolling tracks of the rollers should be located on the bushings themselves, one of the bushings being machined to form the said tracks and the other bushing remaining smooth, therefore no ring is used.

The invention will now be described with reference to the single figure.

A hollow shaft 1 is forced into a hole 2 passing through an epicyclic satellite 3. Side faces 4 provided with stops 5 hold the satellite assembly 3 around the shaft 1 in the axial direction. Roller bearings (6 in this case) are arranged in the hole 2 at equal distances, and they are marked with the general reference 6. The satellite 3 is provided with an inner bushing 7, for which the cylindrical inner surface 8 acts as a rolling track for the rollers 6. The support shaft 1 of the satellite 3 is hollow, in the form of a bushing, and is provided with circular notches 9 on its outside surface, the bottoms of which act as rolling tracks inside the rollers 6, that are thus incapable of moving laterally.

One essential aspect of the invention is that the stiffnesses of the bushing 7 of the satellite 3 and the bushing consisting of the shaft 1 are similar. More precisely, the facing portions of these two bushings on each side of the hole 3 have similar thicknesses if they are made from similar or identical materials, which is usually the case. Thus, the tapered shape of the bushing 7, which is thinner at the ends and thicker at the centre where it is connected to the rest of the satellite 3, corresponds to a similarly tapered shape of the shaft 1 that becomes thinner as the distance from the ends of the hole 2 reduces. It can be seen that with this arrangement, it becomes easier to make the deformation curves of the two bushings similar, and therefore to maintain an equitable share of the load transmitted between the rollers 6. The presence of rings joining several rows of rollers 6 could disturb this uniform distribution of forces. It is then important to check that the similarity of deformations produced on each side of the rollers 6 is respected for each circle of rollers 6.

It is obvious that deformations of the two bushings (or more generally between the shaft and the satellite) could equally well be made similar by respecting criteria other than similar thicknesses, depending on the circumstances and particularly if the materials are different, in the presence of stiffeners, etc.

1. Assembly arrangement for an epicyclic satellite (3), comprising a hole (2) through the satellite, a shaft (1) passing through the hole, and bearings (6) arranged in the hole, characterised in that there are at least three of them, regularly arranged in the hole and composed of rolling elements, and in that the shaft (1) and the satellite (3) include bearing support bushings (1, 7) along the length of the hole, the bushings having similar stiffnesses at each pair of portions facing each other in the hole (2).

2. Assembly arrangement for an epicyclic satellite according to claim 1, characterised in that the rolling elements are rollers and the bearing support bushings include roller rolling tracks, one of the bushings being machined to form the said tracks (9).
